(19) United States
(12) Patent Application Publication
(10) Pub. No.: US 2014/0283694 A1
(43) Pub. Date: Sep. 25, 2014

(54) WHEAT WORKSHOP TECHNIQUE OF WHEAT FLOUR MILLING FOR PEELING OFF PERICARP ONLY AND COMPLETE SET OF EQUIPMENT THEREFOR

(71) Applicants: Hongfu WANG, Zhengzhou (CN); Yi WANG, Zhengzhou (CN)

(72) Inventors: Hongfu WANG, Zhengzhou (CN); Yi WANG, Zhengzhou (CN)

(21) Appl. No.: 14/266,669

(22) Filed: Apr. 30, 2014

Related U.S. Application Data
(63) Continuation of application No. PCT/CN2012/083616, filed on Oct. 26, 2012.

(30) Foreign Application Priority Data
Oct. 31, 2011 (CN) 201110337161.6

(51) Int. Cl. B02B 1/04

(52) U.S. Cl. CPC B02B 1/04
USPC 99/514

(57) ABSTRACT

The present disclosure discloses a cleaning process of wheat flour milling for peeling off the pericarp only, and a set of equipment for implementing the process. The method comprises four stages, namely, cleaning of raw wheat, pericarp peeling-off, cleaning of glossy wheat, and conditioning stage, wherein the peeling-off stage comprises a dampening step and a stirring step. The process only debrans most of the pericarp, without damaging the seed coat. Thus, this greatly reduces the probability of the seed coat being grinded into gluten powder and mixed into wheat flour, thereby reducing the ash content in the wheat flour. The set of equipment obviates a washer, thus conserving water resource and preventing water pollution.

### CROSS-REFERENCE TO RELATED APPLICATIONS

This application is a continuation of International Application No. PCT/CN2012/083616, filed Oct. 26, 2012, which claims priority to Chinese Patent Application No. 201110337161.6, filed Oct. 31, 2011, both of which are hereby incorporated herein by reference in their entirety for all purposes.

### STATEMENT REGARDING FEDERALLY SPONSORED RESEARCH OR DEVELOPMENT

Not applicable.

### BACKGROUND

The present disclosure belongs to the field of wheat processing and, particularly, to a wheat flour milling cleaning workshop process for peeling off pericarp only, and a set of equipment therefor.

A wheat flour milling process includes two parts: wheat cleaning and wheat flour milling. In the wheat flour milling product line, the wheat cleaning workshop is referred to as wheat workshop for short, and the wheat flour milling workshop is referred to as flour workshop for short. Current process flow of wheat workshop process includes five stages which are pre-cleaning (the initial cleaning before grain is stored), cleaning of raw wheat (the wheat after pre-cleaning or the grain without pre-cleaning step), conditioning, cleaning of glossy wheat (the wheat after cleaning of raw wheat) and peeling-off. Wheat cleaning generally comprises winnowing (commonly used equipment includes a vertical suction duct, suction winnower and circulating air dust remover etc.), screening (commonly used equipment includes a vibrating screen and rotary flat screen etc.), gravity grading separation (commonly used equipment includes a destoner and gravity classifier etc.), magnetic separation (commonly used equipment includes a magnetic steel and tubular magnet etc.), fine separation (commonly used equipment includes a disc separator, cylinder separator and spiral separator) and surface cleaning (commonly used equipment includes a wheat scourer and wheat washer etc.) steps. The function of cleaning stage is: removing the foreign matter or dirt of soil and sand, ferromagnetic matter, grass seeds, other grain kernels, wheat straw, wheat awn, shriveled wheat, insect-bitten and molding wheat etc. in the wheat grain. The cleaning stage before entering raw wheat warehouse of current process is referred to as pre-cleaning stage. The pre-cleaning stage generally comprises a screening and a winnowing or only a screening. The cleaning stage before entering wheat dampening warehouse is referred to as raw wheat cleaning stage, which generally comprises a total of six stages that are a winnowing, a screening, a magnetic separation, a gravity grading separation, a fine separation and a surface processing. Usually the cleaning of glossy wheat stage is only one fine separation step less than the cleaning of raw wheat stage. The conditioning stage comprises a dampening step (commonly used equipment includes a powerful dampener, dampening mixer and spray dampener etc.) and a wheat wetting step (the wheat is stored for a period of time in the wheat wetting warehouse after dampening). The function of the conditioning stage is: improving the physical, biochemical and processing characteristics of the brans and endosperm of wheat through dampening and wheat wetting, enhancing the process effect of wheat flour milling.

The peeling-off step in current process is configured to debran as many wheat brans (including seed coat and pericarp) as possible, decrease the ash content of the wheat before milling, thereby decreasing the ash content of the flour produced from product line, and increasing the purity of the flour and edible quality. As the bran of wheat is thick and with high strength, the bond between seed coat and endosperm is very strong, and wheat kernel has a groove deeply sunk and the surface area of which is about one third of the total surface area of the wheat. Current processes use equipment with both the structure and working principle similar to a rice husker, and can only debran 30%-60% of the brans of wheat after dampening properly and wetting wheat over 20 hours, and the percentage of broken kernels can reach 1%-3%. The probability that the seed coat remaining on the milled wheat kernels, which already has been milled thinner or damaged after the peeling-off step, is grinded into fine gluten powder in the following several repeated grinding and flour milling stages in the flour workshop and mixed into flour, is much higher than without the peeling-off stage. As a result, the ash content of the wheat before milling is apparently decreased, the ash content of the produced flour is decreased not obviously or even increased frequently. The current wheat peeling-off and flour milling processes have the disadvantages of high energy consumption and the wheat conglomerating in the wetting warehouse due to endosperm exposed to the air after peeling-off which affects production, therefore is used very rarely.

### BRIEF SUMMARY OF THE DISCLOSURE

According to the preceding situation, it is the objective of the present disclosure to provide a wheat flour milling cleaning workshop process for peeling off pericarp only, and a set of equipment.

In order to achieve the preceding objective, the present disclosure uses the following technical solutions:

A wheat flour milling cleaning workshop process for peeling off pericarp only comprises four stages which are cleaning of raw wheat, pericarp peeling-off, cleaning of glossy wheat, and conditioning stage, wherein the peeling-off stage comprises a dampening stage and a stirring stage.

The detailed steps of the peeling-off stage are: the wheat is added with water of 1-5% of the weight of the wheat, the water temperature is 10-60° C., then sent to the stirring step for processing within 10 minutes after dampening, the height of the wheat is controlled to be within 0.5-3 m.

A stirrer is used during stirring, and the linear velocity of the stirring rod of the stirrer is controlled to be 1-6 m/S.

The stirring is done one to four times, the pericarp peeled off is removed by screening or winnowing after each stirring during the repeated stirring.

The cleaning of raw wheat stage comprises screening, winnowing, magnetic separation, second screening and second winnowing, the cleaning of glossy wheat stage comprises magnetic separation, destoning, screening and winnowing steps, the conditioning stage comprises dampening and wheat wetting steps.

A set of equipment used for wheat flour milling cleaning workshop process for peeling off pericarp only may comprise a material pit, a first hoister, a first vibrating screen, a first vertical suction duct, a helical conveyor, a raw wheat warehouse, a second hoister, a first magnetic separator, a second vibrating screen, a second vertical suction duct, a first destoner, a first dampener, a stirrer, a third hoister, a second magnetic separator, a second destoner, a third vibrating screen, a third vertical suction duct, a second dampener, a wheat wetting warehouse, a forth hoister, a third dampener and wheat cleaning warehouse.

The material pit and the upper outlet of the first vertical suction duct connect the first wind net device; the second vertical suction duct, the first destoner, the second destoner, the upper outlet of the third vertical suction duct connect the second wind net device.

The first wind net device and the second wind net device comprise a fan and centrifugal dust collector, respectively.

The objective of the dampening is to drive moisture into the pericarp of the wheat, separating the pericarp and the seed coat. The water temperature, the amount of the water and the dampening time should be noticed during dampening. The water temperature of the dampening is controlled to be within 10-60° C., generally by using workshop temperature, water can achieve a good peeling-off effect; slightly increasing the water temperature can make the water permeate into the pericarp layer more quickly, and avail the pericarp separation. However, if the temperature is too high, for example over 60 degrees, it can damage and cure the protein in the wheat, destroy the quality of the wheat, as well as over consume energy. The amount of the dampening water is controlled to be within 0.5-5% times the weight of the wheat. As the objective of dampening is to wet the pericarp, too much dampening does not improve results and wastes the water resource. The dampening time is controlled generally to be within 10 minutes, as the pericarp will separate from the seed coat within a short time after the dampening, if the dampening time is too long, the seed coat will absorb the water, making the pericarp stick back to the corn again, and hinder the pericarp peeling-off. The dampening step can use liquid water to spray to the wheat, or steam to process the wheat.

The purpose of the stirred peeling-off is: keep the wheat on a certain height, and the lower wheat layer bears the pressure from the upper wheat layer to generate a holding force which generates a relative force with the stirring force of the stirring rod; thus, peeling off the pericarp layer of the wheat. The height of the wheat should be controlled to be within 0.5-3 meters, if the height of the wheat is too low, the holding force is not enough to achieve a better peeling-off effect; if the height of the wheat is too high, then the holding force of the wheat is too intense which can increase the energy consumption of the stirred peeling-off, and break the wheat due to the over applying force to produce the side effect. The stirring rod can be the type of inserting a blade in the rod, scraping off the pericarp of the wheat during stirring, meanwhile the wheat can rub each other during stirring, and debran part of the pericarp. Controlling the linear velocity of the stirring rod determines the force that the stirring rod applies on the material kernels, and a too high velocity can increase the energy consumption, also result in the side effect of over scraping. The whole or part of the stirred peeling-off step can be repeated to increase the peeling off rate, and improve the process effect. The stirring is done one to four times, when the peeling off of the first stirring is not complete, stirring times are added. The debranned brans are removed by screening or winnowing after each stirring during the repeated stirring to prevent the brans from affecting the stirring effect.

The stirred peeling-off step of the present disclosure can employ a stirrer which comprises a vertical cylindrical vessel component, a stirrer comprises several cylindrical stirring rods equipped with elongated scraper that is configured vertically on the horizontal crossed stirring rod hanger, actuator and rack etc. components (detailed in Patent CN2009101577602). When the stirrer is working, the pericarp of wheat is scraped off by the sharp scraper at the cutting edge. As the pericarp of wheat is thin, low-intensitive and readily swelling by absorbing water, the bond with seed coat is decreasing after swelling, thus the pericarp can be separated from seed coat by applying a little mechanical agitation, however, the strength of the seed coat of wheat is much higher than the pericarp, the bond between the seed coat and endosperm is quite firm, making it very hard to be separated and broken, also the wheat kernels loosely stored in the vessel can rotate freely when it is scraped by the scraper, thus most of the pericarp except the inner pericarp layer in the groove of the wheat can be peeled off on the premise of substantially not damaging the seed coat as long as controlling the material height in the vessel and the rotary speed of the stirrer within certain range.

The present disclosure describes peeling off the pericarp only without damaging the seed coat of wheat, which has the advantages below:

Peeling off most of the pericarp in the wheat workshop, and basically not damaging the seed coat, this greatly reduces the probability of the seed coat being grinded into gluten powder and mixed into wheat flour, thereby reducing the ash content in the wheat flour from product line over 0.02 percentage point;

Peeling off adhered dust, dirt and pesticide residual of most of the pericarp, reducing the sand content, the colony count of the produced flour, largely improving the cleanness and the edible quality, and extending the storage life of the flour;

Being able to produce the wheat bran with over 80% of the seed coat which is used to produce edible cellulose, will largely improve the value of deep processing of the wheat;

As the stirring stage can debran most of the pericarp adhered with dirt, the present disclosure does not require any surface cleaning equipment, for example a wheat scourer and a wheat washer etc., and has the advantages of cutting down the number of the equipment, reducing the process flow and decreasing energy consumption etc.;

As the present disclosure does not require a wheat washer, saving the water, by setting up a medium-sized flour factory for example, the water resource saved each year can be tens of thousands tons, and water pollution thereof can be also avoided, the economical and social benefits are tremendous.

### BRIEF DESCRIPTION OF THE DRAWINGS

FIG. 1 is the flow diagram of the wheat flour milling cleaning workshop process for peeling off pericarp only of the present disclosure.

### DETAILED DESCRIPTION OF THE PREFERRED EMBODIMENTS

The technical solutions of the present disclosure are further described below with preferred embodiments, and the protection scope of the present disclosure is not intended to be limited herein.

A wheat flour milling cleaning workshop process for peeling off pericarp only, the process flow of which is cleaning of raw wheat (screening, winnowing, magnetic separation, second screening and second winnowing), pericarp peeling-off (dampening and stirring), cleaning of glossy wheat (magnetic separation, destoning, screening and winnowing), and conditioning stage (dampening and wheat wetting).

The detailed steps of the peeling-off stage are: adding wheat with water of about 3% of the weight of the wheat, the water temperature is about 35° C., the wheat is sent to the stirring step for processing within 10 minutes after dampening, the height of the wheat is controlled to be within 0.5-3 m, a stirrer is employed during stirring, the linear velocity of the stirring rod of the stirrer is controlled to be 1-6 m/S; the stirring can be done one to four times, the pericarp peeled off is removed by screening or winnowing after each stirring during the repeated stirring.

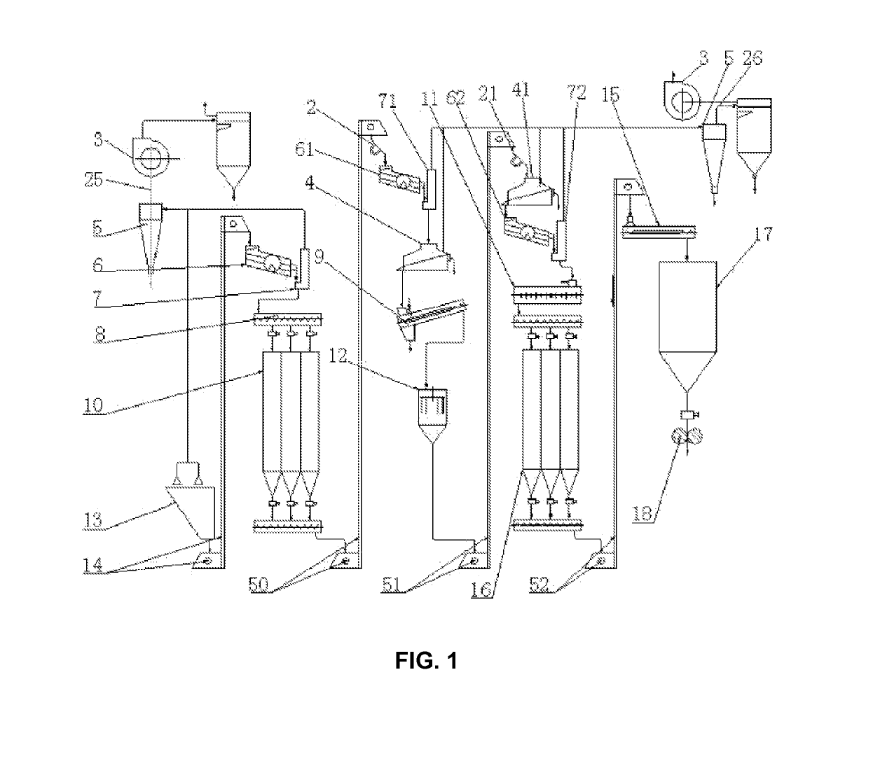

A set of equipment used for the preceding wheat flour milling cleaning workshop process for peeling off pericarp only, see FIG. 1, the set of equipment comprises a material pit 13, a first hoister 14, a first vibrating screen 6, a first vertical suction duct 7, a helical conveyor 8, a raw wheat warehouse 10, a second hoister 50, a first magnetic separator 2, a second vibrating screen 61, a second vertical suction duct 71, a first destoner 4, a first dampener 9, a stirrer 12, a third hoister 51, a second magnetic separator 21, a second destoner 41, a third vibrating screen 62, a third vertical suction duct 72, a second dampener 11, a wheat wetting warehouse 16, a forth hoister 52, a third dampener 15 and a wheat cleaning warehouse 17 that are connected in sequence, the outlet of the wheat cleaning warehouse 17 connects the rolling miller 18; the material pit 13 and the upper outlet of the first vertical suction duct 7 connect the first fan net device 25; the second vertical suction duct 71, the first destoner 4, the second destoner 41, the upper outlet of the third vertical suction duct 72 connect the second fan net device 26, the first fan net device 25, the second fan net device 26 comprises a fan 3 and a centrifugal dust collector 5 respectively.

When the set of equipment is in operation, the wheat in the material pit 13 is transported by the first hoister 14, and sent to the first vibrating screen 6 and the first vertical suction duct 7 for removing the big and small sized impurities and light impurities, then sent to the raw wheat warehouse 10 by the helical conveyor 8 to be stored. The wheat exported from the raw wheat warehouse 10 goes through the first magnetic separator 2 to remove the ferromagnetic impurities, the second vibrating 61 and the second vertical suction duct 71 are used to remove the big and small sized impurities and light impurities, and the first destoner 4 is used to remove the heavy impurities of stones etc. The wheat is then sent to the stirrer 12 for pericarp peeling-off after dampening the wheat with the first dampener 9; the debranned wheat is transported again by the third hoister 51, through the second magnetic separator 21 to remove the ferromagnetic impurities, then sent to the second destoner 41 to remove the stone again. The third vibrating screen 62 and the third vertical suction duct 72 are used to remove the big and small sized impurities and light impurities mainly with pericarp. After the wheat is dampened with the second dampener 11, then sent to the wetting warehouse 16 by helical conveyor to wet for 16-28 hours; the wetted wheat is transported by the forth hoister 52, and sent to the cleaning warehouse 17, after being dampened with the third dampener 15, to be stored. The wheat exported from cleaning warehouse 17 is milled by the rolling miller 18.

The first fan net device 25 is used to collect the impurities of dust, wheat straw, rope head, grass seed, paper and plastic sheet etc. before the wheat enters the raw wheat warehouse, which are generally utilized for waste treatment. The second wind net device 26 is used to collect the impurities of pericarp, wheat awn, grass seed and shriveled wheat etc. after the wheat leaves the raw wheat warehouse, wherein the wheat is the leftovers of the wheat workshop of the product line, which are generally ground and mixed into the wheat bran.

What is claimed is:

1. A wheat workshop technique of wheat flour milling for peeling off pericarp only, comprising four stages: cleaning of raw wheat, pericarp peeling-off, cleaning of glossy wheat, and conditioning stages, wherein the peeling-off stage comprises a dampening step and a stirring step.

2. The wheat workshop technique of wheat flour milling for peeling off pericarp only according to claim 1, wherein detailed steps of the peeling-off stage are: adding to the wheat with water of 1-5% of the weight of the wheat, the water temperature being 10-60 ° C., and the wheat is sent to the stirring step for processing within 10 minutes after dampening, height of the wheat is controlled to be within 0.5-3 m.

3. The wheat workshop technique of wheat flour milling for peeling off pericarp only according to claim 1, wherein a stirrer is employed when stirring, linear velocity of the stirring rod of the stirrer is 1-6 m/S.

4. The wheat workshop technique of wheat flour milling for peeling off pericarp only according to claim 3, wherein the stirring is repeated for one to four times, the pericarp peeled off is removed by screening or winnowing after each stirring during repeated stirring.

5. The wheat workshop technique of wheat flour milling for peeling off pericarp only according to claim 4, wherein the cleaning of the raw wheat stage comprises a screening, a winnowing, a magnetic separation, a second screening and a second winnowing, the cleaning of the glossy wheat stage comprises a magnetic separation, a destoning, a screening and a winnowing steps, the conditioning stage comprises a dampening and a wheat wetting steps.

6. A set of equipment for the wheat workshop technique of wheat flour milling for peeling off pericarp only according to claim 1, comprising a material pit, a first hoister, a first vibrating screen, a first vertical suction duct, a helical conveyor, a raw wheat warehouse, a second hoister, a first magnetic separator, a second vibrating screen, a second vertical suction duct, a first destoner, a first dampener, a stirrer, a third hoister, a second magnetic separator, a second destoner, a third vibrating screen, a third vertical suction duct, a second dampener, a wheat wetting warehouse, a forth hoister, a third dampener and wheat cleaning warehouse that are connected in sequence.

7. The set of equipment for the wheat workshop technique of wheat flour milling for peeling off pericarp only according to claim 6, wherein the material pit and upper outlet of the first vertical suction duct connected to the first wind net device; upper outlets of the second vertical suction duct, the first destoner, the second destoner, the third vertical suction duct connected to the second wind net device.

8. The set of equipment for the wheat workshop technique of wheat flour milling for peeling off pericarp only of claim 6, wherein the first wind net device, the second wind net device comprises a fan and a centrifugal dust collector respectively.

9. The set of equipment for the wheat workshop technique of wheat flour milling for peeling off pericarp only of claim 7, wherein the first wind net device, the second wind net device comprises a fan and a centrifugal dust collector respectively.

10. The wheat workshop technique of wheat flour milling for peeling off pericarp only according to claim 2, wherein a stirrer is employed when stirring, linear velocity of the stirring rod of the stirrer is 1-6 m/S.

11. The wheat workshop technique of wheat flour milling for peeling off pericarp only according to claim 10, wherein the stirring is repeated for one to four times, the pericarp peeled off is removed by screening or winnowing after each stirring during repeated stirring.

12. The wheat workshop technique of wheat flour milling for peeling off pericarp only according to claim 11, wherein the cleaning of the raw wheat stage comprises a screening, a winnowing, a magnetic separation, a second screening and a second winnowing, the cleaning of the glossy wheat stage comprises a magnetic separation, a destoning, a screening and a winnowing steps, the conditioning stage comprises a dampening and a wheat wetting steps.
